(19) United States
(12) Patent Application Publication
(10) Pub. No.: US 2014/0225568 A1
(43) Pub. Date: Aug. 14, 2014

(54) GATE DRIVING CIRCUIT AND BATTERY MANAGEMENT SYSTEM INCLUDING THE SAME

(71) Applicant: FAIRCHILD KOREA SEMICONDUCTOR LTD., Bucheon-si (KR)

(72) Inventor: Jinhwa CHUNG, Seoul (KR)

(73) Assignee: FAIRCHILD KOREA SEMICONDUCTOR LTD., Bucheon-si (KR)

(21) Appl. No.: 14/177,949

(22) Filed: Feb. 11, 2014

(30) Foreign Application Priority Data
Feb. 13, 2013 (KR) 10-2013-0015505

(51) Int. Cl. H02J 7/00

(52) U.S. Cl. CPC H02J 7/0031
USPC 320/112; 327/109

(57) ABSTRACT

There are provided a gate driving circuit and a battery management system including the same. The gate driving circuit is coupled to a gate of a charging switch through a charging pin. The gate driving circuit includes a first transistor for performing a switching operation in accordance with a gate control signal to control a connection between a power supply voltage and a charging pin, a second transistor having a switching operation controlled in synchronization with a switching state of the first transistor and coupled between the charging pin and the first transistor, and a diode coupled between the first transistor and the second transistor and positive biased by the power supply voltage.

### CROSS-REFERENCE TO RELATED APPLICATION

This application claims priority to and the benefit of Korean Patent Application No. 10-2013-0015505 filed in the Korean Intellectual Property Office on Feb. 13, 2013, the entire contents of which are incorporated herein by reference.

### BACKGROUND

(a) Field

Exemplary embodiments relate to a gate driving circuit and a battery management system including the same.

(b) Description of the Related Art

A battery management system generates a gate signal for controlling a switching operation of a charging switch. The charging switch controls an electrical connection between a battery pack formed of a plurality of battery cells and a charger. The battery pack is charged by a current supplied from the charger in a period where the charging switch is in an on state.

FIG. 1 is a view illustrating a conventional battery management system.

As illustrated in FIG. 1, a resistor 2 is connected between a gate and a source of a charging switch 1 and a resistor 4 is connected between the gate of the charging switch 1 and a charging pin 3.

Although a battery pack 5 is connected to a charger 6, the charging switch 1 may be in an off state. For example, charge may be completed or a protecting operation may be triggered so that the charging switch 1 may be turned off.

When the charging switch 1 is in an off state in a state where the battery pack 5 and the charger 6 are connected to each other, a gate voltage of the charging switch 1 may be a negative voltage, which may cause an erroneous operation of a battery management system 7.

For example, a parasitic transistor may be turned on in a gate driving circuit (not shown) of the battery management system 7. Then, a current that flows through the parasitic transistor may be generated and the gate driving circuit may erroneously operate.

The above information disclosed in this Background section is only for enhancement of understanding of the background of the invention and therefore it may contain information that does not form the prior art that is already known in this country to a person of ordinary skill in the art.

### SUMMARY

Exemplary embodiments provide a gate driving circuit and a battery management system including the same capable of preventing an erroneous operation from being performed during charge.

According to an exemplary embodiment, a gate driving circuit coupled to a gate of a charging switch through a charging pin includes a first transistor for performing a switching operation in accordance with a gate control signal to control a connection between a power supply voltage and a charging pin, a second transistor coupled between the charging pin and the first transistor, and a diode coupled between the first transistor and the second transistor and positive biased by the power supply voltage. A switching operation of the second transistor is controlled in synchronization with a switching state of the first transistor.

The gate driving circuit further includes a third transistor configured to perform a switching operation in accordance with the gate control signal to control the switching operation of the second transistor.

One end of the first transistor is coupled to the power supply voltage, the other end of the first transistor is coupled to an anode of the diode, and an inverted gate control signal obtained by inverting the gate control signal is input to a gate of the first transistor.

The gate control signal is input to a gate of the third transistor.

One end of the third transistor is coupled to a ground, the other end of the third transistor is coupled to a gate of the second transistor, and the gate control signal is input to the gate of the third transistor.

One end of the second transistor is coupled to a cathode of the diode and the other end of the second transistor is coupled to the charging pin.

The gate driving circuit further includes a resistor coupled between a gate electrode of the second transistor and one end of the second transistor.

The gate driving circuit further includes a zener diode including an anode coupled to the gate electrode of the second transistor and a cathode coupled to one end of the second transistor.

According to an exemplary embodiment, a gate driving circuit includes a first transistor coupled to a power supply voltage and formed on a P-type semiconductor substrate, a diode including an anode coupled to the first transistor and formed on the P-type semiconductor substrate, and a second transistor coupled to a cathode of the diode and formed on the P-type semiconductor substrate. The second transistor includes a first N-type semiconductor region formed by being implanted into the P-type semiconductor substrate, a first P-type semiconductor region coupled to a cathode of the diode and formed by being implanted into the first N-type semiconductor region, and a second P-type semiconductor region formed by being implanted into the first N-type semiconductor region.

The diode includes a second N-type semiconductor region coupled to the first P-type semiconductor region and formed by being implanted into the P-type semiconductor substrate and a third P-type semiconductor region formed by being implanted into the second N-type semiconductor region.

The first transistor includes a third N-type semiconductor region formed by being implanted into the P-type semiconductor substrate, a fourth P-type semiconductor region formed by being implanted into the third N-type semiconductor region and coupled to the power supply voltage, and a fifth P-type semiconductor region formed by being implanted into the third N-type semiconductor region and coupled to the third P-type semiconductor region.

The gate driving circuit further includes a third transistor coupled between the gate electrode of the second transistor and a ground.

The third transistor includes a fourth N-type semiconductor region coupled to the gate electrode of the second transistor and the first P-type semiconductor region through a resistor and formed by being implanted into the P-type semiconductor substrate, a sixth P-type semiconductor region formed by being implanted into the fourth N-type semiconductor region, and a fifth N-type semiconductor region formed by being implanted into the sixth P-type semiconductor region.

A signal supplied to a gate electrode of the first transistor and a signal supplied to a gate electrode of the third transistor are inverted to each other.

A parasitic transistor formed among the P-type semiconductor substrate, the first N-type semiconductor region, and the second P-type semiconductor region is not turned on by a negative voltage supplied to the second P-type semiconductor region when the second transistor is turned off.

According to an exemplary embodiment, a battery management system manages a battery pack including a plurality of cells. The battery management system includes a charging pin coupled to a gate of a charging switch for controlling charge of the battery pack, a gate driving circuit configured to switch the charging switch, and a controller configured to generate a gate control signal in accordance with a result obtained by measuring voltages of the plurality of cells and a current that flows through the battery pack. The gate driving circuit includes a first transistor for performing a switching operation in accordance with an inverted gate control signal obtained by inverting the gate control signal to control a connection between a power supply voltage and a charging pin, a second transistor coupled between the charging pin and the first transistor, and a diode coupled between the first transistor and the second transistor and positive biased by the power supply voltage. A switching operation of the second transistor is controlled in synchronization with a switching state of the first transistor

The gate driving circuit further includes a third transistor configured to perform a switching operation in accordance with the gate control signal to control a switching operation of the second transistor.

One end of the first transistor is coupled to the power supply voltage, the other end of the first transistor is coupled to an anode of the diode, and the inverted gate control signal is input to a gate of the first transistor.

One end of the third transistor is coupled to a ground, the other end of the third transistor is coupled to a gate of the second transistor, and the gate control signal is input to a gate of the third transistor.

One end of the second transistor is coupled to a cathode of the diode and the other end of the second transistor is coupled to the charging pin.

According to the exemplary embodiment, there are provided a gate driving circuit capable of preventing an erroneous operation from being performed during charge and a battery management system including the same.

### BRIEF DESCRIPTION OF THE DRAWINGS

FIG. 1 is a view illustrating a conventional battery management system.

FIG. 2 is a view illustrating a gate driving circuit according to an exemplary embodiment.

FIG. 3 is a view illustrating a conventional gate driving circuit.

FIG. 4 is a view illustrating a part of a substrate on which the conventional gate driving circuit illustrated in FIG. 3 is formed.

FIG. 5 is a view illustrating a section of a substrate on which a gate driving circuit according to an exemplary embodiment is formed.

FIG. 6 is a view illustrating a battery management system including a gate driving circuit according to an exemplary embodiment.

FIG. 7 is a view illustrating a gate driving circuit according to another exemplary embodiment.

### DETAILED DESCRIPTION OF THE EMBODIMENTS

In the following detailed description, only certain exemplary embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Hereinafter, a gate driving circuit according to exemplary embodiments and a battery management system including the same will be described.

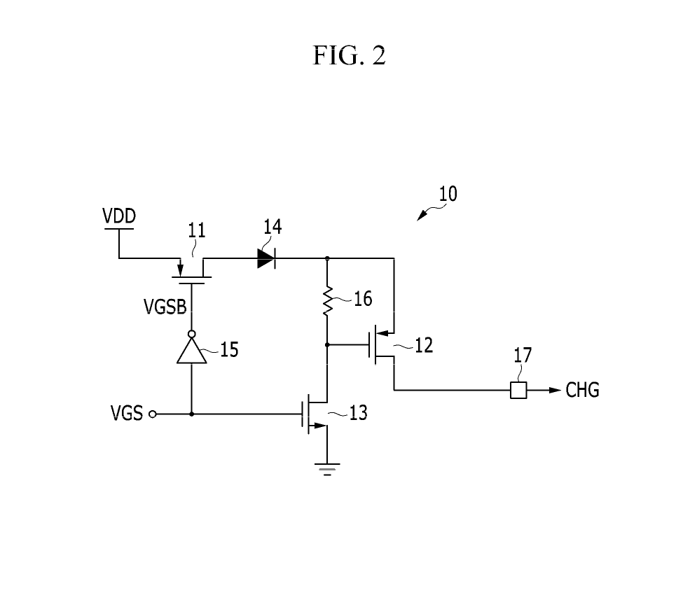

FIG. 2 is a view illustrating a gate driving circuit according to an exemplary embodiment.

As illustrated in FIG. 2, a gate driving circuit 10 includes first to third transistors 11 to 13, a diode 14, an inverter 15, and a resistor 16. The first and second transistors 11 and 12 are p channel transistors and the third transistor 13 is an n channel transistor.

An output end of the gate driving circuit 10 is connected to a charging pin 17 and a gate control signal VGS is input to an input end of the gate driving circuit 10. The charge gate signal VGS is output through the charging pin 17.

The first transistor 11, the diode 14, and the second transistor 12 are serially connected between the charging pin 17 and a power supply voltage VDD. The third transistor 13, the resistor 16, and the second transistor 12 are connected between the charging pin 17 and a ground.

The inverter 15 receives and inverts the gate control signal VGS and outputs the inverted gate control signal VGS to a gate of the first transistor 11. A gate of the third transistor 13 is connected to the gate control signal VGS. Hereinafter, an output of the inverter 16 is referred to as an inverted gate control signal VGSB.

In FIG. 2, the first transistor 11 performs a switching operation in accordance with the inverted gate control signal VGSB. However, the exemplary embodiment is not limited thereto. The inverted gate control signal VGSB is input in accordance with a type of the first transistor 11. When the first transistor 11 is realized by an n channel transistor having a channel type opposite to that illustrated in FIG. 2, the switching operation of the first transistor 11 may be controlled in accordance with the gate control signal VGS.

The first transistor 11 is connected between the power supply voltage VDD and the charging pin 17 to control a connection between the power supply voltage VDD and the charging pin 17. A source of the first transistor 11 is connected to the power supply voltage VDD and a drain of the first transistor 11 is connected to an anode of the diode 14.

A switching operation of the second transistor 12 is in synchronization with a switching state of the first transistor 11. For example, when the first transistor 11 is in an on state in accordance with the inverted gate control signal VGSB, since the third transistor 13 is also in an on state, a gate of the second transistor 12 is connected to the ground so that the second transistor 12 is turned on.

In addition, when the first transistor 11 is in an off state in accordance with the inverted gate control signal VGSB, since the third transistor 13 is also in an off state, a voltage difference is not generated between the gate and a source of the second transistor 12 so that the second transistor 12 is turned off.

A cathode of the diode 14 is connected to the source of the second transistor 12 and a drain of the second transistor 12 is connected to the charging pin 17. The diode 14 is positive biased by the power supply voltage VDD so that the power supply voltage VDD is conducted to be connected to the charging pin 17.

Hereinafter, an operation of the gate driving circuit 10 will be described in detail.

When the gate control signal VGS is at a high level, the first transistor 11 is turned on by a low level inverted gate control signal VGSB and the third transistor 13 is turned on by a high level gate control signal VGS. Then, the gate of the second transistor 12 is connected to the ground and the source of the second transistor 12 is connected to the power supply voltage VDD through the diode 14 so that the second transistor 12 is turned on.

When the gate control signal VGS is at a low level, the first transistor 11 is turned off by a high level inverted gate control signal VGSB and the third transistor 13 is turned off by a low level gate control signal VGS. The gate and the source of the second transistor 12 are connected by the resistor 16 to be turned off. As the second transistor 12 is turned off, a charge gate signal CHG is at a low level.

When the battery management system is connected to a load, a current may be received through the charging pin 17. Since the gate control signal VGS is at a low level while the battery management system is connected to the load, the second transistor 12 is in an off state. However, the current received through the charging pin 17 may flow through a body diode (not shown) of the second transistor 12.

Since the cathode of the diode 14 is connected to the source of the second transistor 12, a current is prevented from flowing by the diode 14.

When the battery management system is connected to a charger, the gate control signal VGS may be at a low level. At this time, a negative voltage may be generated by the charging pin 17. Since the first transistor 11 and the second transistor 12 are in off states, a current that flows from the power supply voltage VDD to the charging pin 17 is not generated.

Since the gate and the drain of the second transistor 12 are insulated from each other, although a voltage of the charging pin 17 connected to the drain becomes a negative voltage, a current that flows from the ground to the charging pin 17 is not generated.

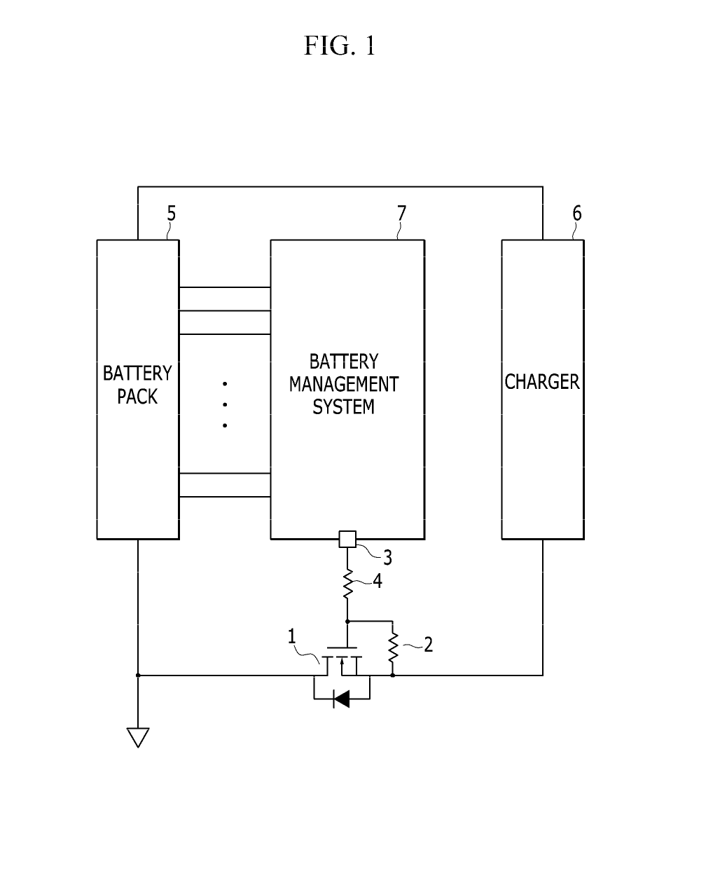

In a conventional gate driving circuit, a parasitic transistor is turned on by a negative voltage of a charging pin 3 of FIG. 1 so that a current that flows to the charging pin 3 is generated.

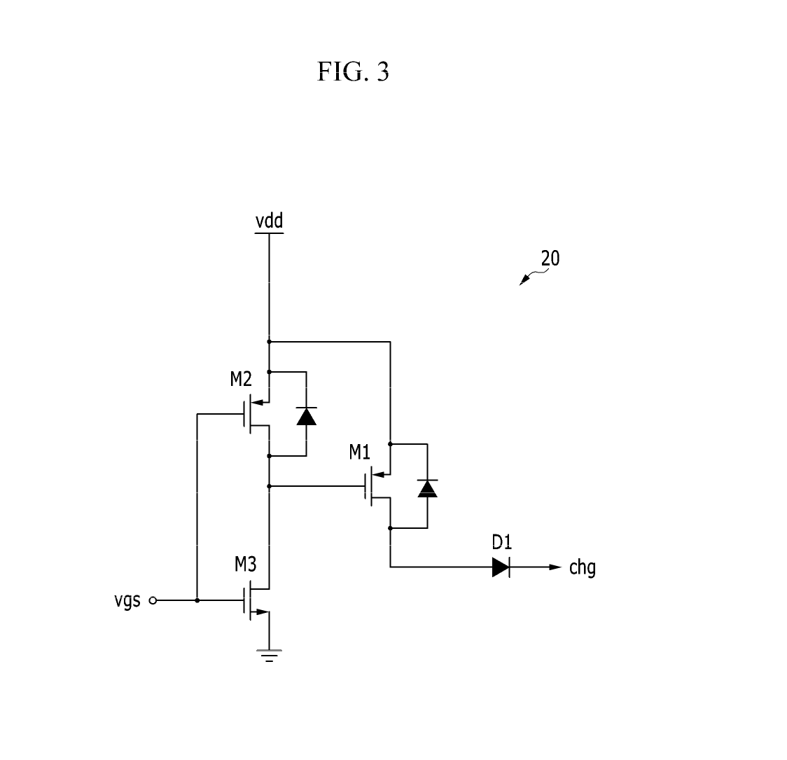

FIG. 3 is a view illustrating a conventional gate driving circuit.

As illustrated in FIG. 3, a conventional gate driving circuit 20 includes three transistors M1, M2, and M3 and a diode D1.

A gate control signal vgs is input to a gate of the transistor M2 and a gate of the transistor M3. A drain of the transistor M2, a drain of the transistor M3, and a gate of the transistor M1 are connected to each other.

A source of the transistor M3 is connected to a ground and a source of the transistor M2 is connected to a voltage vdd. A source of the transistor M1 is connected to the voltage vdd and a drain of the transistor M1 is connected to an anode of the diode D1. A charge gate signal chg is output through a cathode of the diode D1.

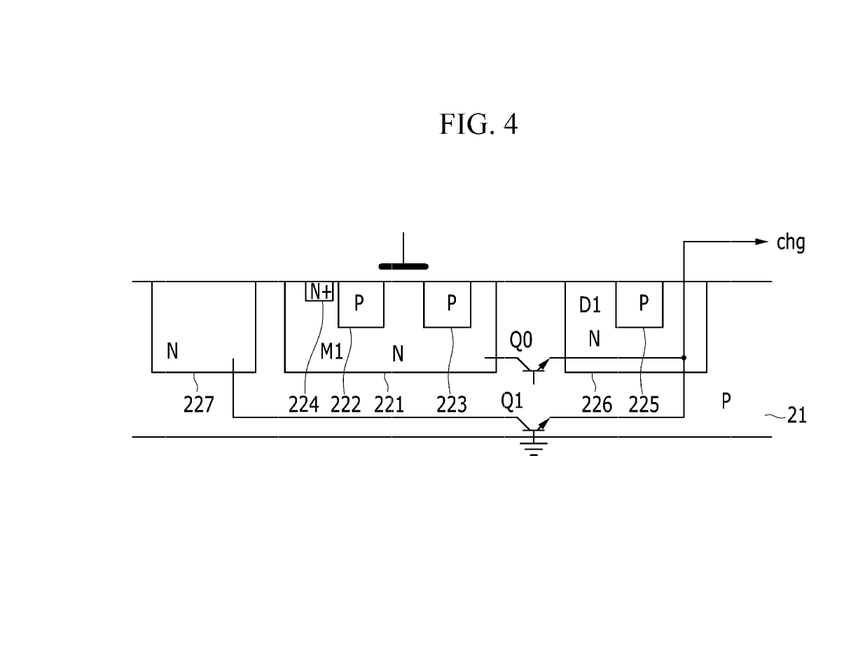

FIG. 4 is a view illustrating a part of a substrate on which the conventional gate driving circuit illustrated in FIG. 3 is formed.

A substrate 21 is a P-type semiconductor region and the transistor M1 includes an N-type semiconductor region 221 that forms a bulk, a P-type semiconductor region 222 that forms a source, and a P-type semiconductor region 223 that forms a drain. An N+ region 224 forms a contact. The diode D1 includes an N-type semiconductor region 226 and a P-type semiconductor region 225.

In a case where a battery management system is connected to a charger, when a charging switch is turned off, the charge gate signal chg has a negative voltage. Then, a parasitic transistor Q0 among the N-type semiconductor region 226 of the diode D1, the substrate 21 that is the P-type semiconductor, and the N-type semiconductor region 221 of the transistor M1 is turned on.

In addition, a parasitic transistor Q1 among an N-type semiconductor region 227 of another transistor M2 or M3, the substrate 21 that is the P-type semiconductor, and the N-type semiconductor region 226 of the diode D1 is also turned on.

Then, a current flows through the parasitic transistors Q0 and Q1 so that a change in the charge gate signal chg is generated and the charging switch may erroneously operate. In addition, when the current that flows through the parasitic transistors Q0 and Q1 is remarkably large, the battery management system may be damaged.

The gate driving circuit 10 according to the exemplary embodiment prevents a current from being generated by the negative voltage of the charging pin 17 using the third transistor 13.

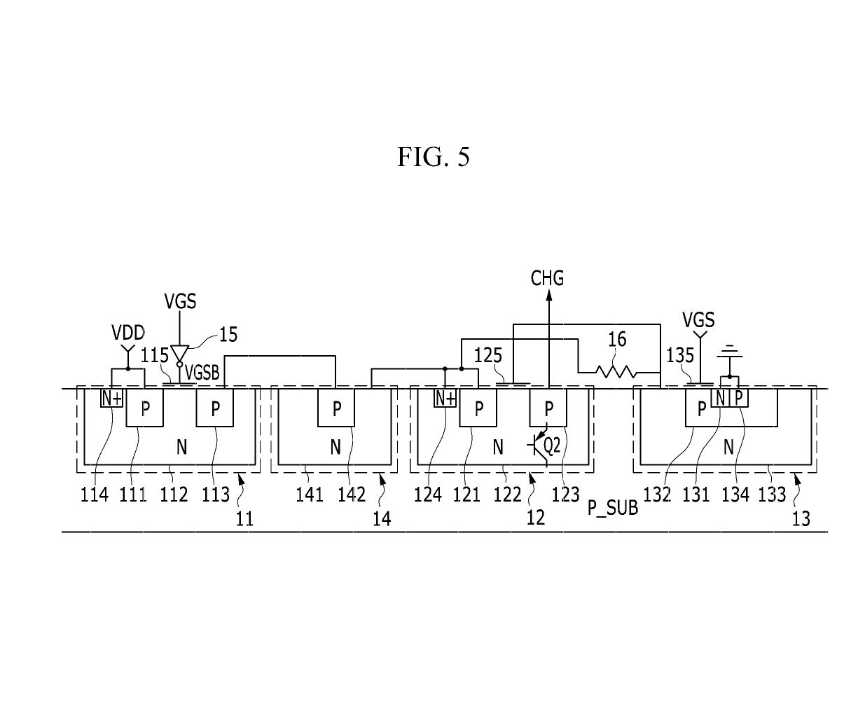

FIG. 5 is a view illustrating a section of a substrate on which a gate driving circuit according to an exemplary embodiment is formed.

As illustrated in FIG. 5, the first to third transistors 11 to 13 and the diode 14 are formed on a P-type semiconductor substrate (hereinafter, P_SUB). The first and second transistors 11 and 12 are P channel transistors and the third transistor 13 is an N channel transistor.

The first transistor 11 includes a P-type semiconductor region 111 that forms a source, an N-type semiconductor region 112 that forms a bulk, a P-type semiconductor region 113 that forms a drain, and an N+ region 114 that forms a contact.

The N-type semiconductor region 112 is formed by being implanted into the P_SUB and the P-type semiconductor region 111 and the P-type semiconductor region 113 are formed by being implanted into the N-type semiconductor region 112. The N+ region 114 is formed by being implanted into the N-type semiconductor region 112. The N+ region 114 and the P-type semiconductor region 111 are adjacent to each other and are connected to the power supply voltage VDD.

The inverted gate control signal VGSB is supplied to a gate electrode 115. A channel is formed in the N-type semiconductor region 112 between the P-type semiconductor region 111 and P-type semiconductor region 113 by the low level inverted gate control signal VGSB.

The diode 14 includes an N-type semiconductor region 141 and a P-type semiconductor region 142. The N-type semiconductor region 141 is formed by being implanted into the P_SUB. The P-type semiconductor region 142 is formed by being implanted into the N-type semiconductor region 141. The P-type semiconductor region 142 and the N-type semiconductor region 141 form a PN junction. The P-type semiconductor region 142 is connected to the P-type semiconductor region 113 of the first transistor 11.

The second transistor 12 includes a P-type semiconductor region 121 that forms a source, an N-type semiconductor region 122 that forms a bulk, a P-type semiconductor region 123 that forms a drain, and an N+ region 124 that forms a contact.

The N-type semiconductor region 122 is formed by being implanted into the P_SUB. The P-type semiconductor region 121 and the P-type semiconductor region 123 are formed by being implanted into the N-type semiconductor region 122. The N+ region 124 is formed by being implanted into the N-type semiconductor region 122. The N+ region 124 and the P-type semiconductor region 121 are adjacent to each other and are connected to the N-type semiconductor region 141 of the diode 14 and one end of the resistor 16.

The charge gate signal CHG is output through the P-type semiconductor region 123. A gate electrode 125 and the other end of the resistor 16 are connected to the N-type semiconductor region 133 of the third transistor 13. When a low level voltage is supplied to the gate electrode 125, a channel is formed in the N-type semiconductor region 122 between the P-type semiconductor region 121 and the P-type semiconductor region 123.

The third transistor 13 includes an N-type semiconductor region 131 that forms a source, a P-type semiconductor region 132, an N-type semiconductor region 133 that forms a drain, and a P-type semiconductor region 134.

The N-type semiconductor region 133 is formed by being implanted into the P_SUB. The P-type semiconductor region 132 is formed by being implanted into the N-type semiconductor region 133. The N-type semiconductor region 131 and the P-type semiconductor region 134 are formed by being implanted into the P-type semiconductor region 132.

The P-type semiconductor region 134 as a body of the third transistor 13 is connected to a ground. The third transistor 13 is body biased. The N-type semiconductor region 131 is adjacent to the P-type semiconductor region 134 and is connected to the ground.

The gate control signal VGS is supplied to a gate electrode 135. A channel is formed in a P-type semiconductor region between the N-type semiconductor region 133 and the N-type semiconductor region 131 by the high level gate control signal VGS.

As illustrated in FIG. 5, a parasitic transistor Q2 is formed among the P-type semiconductor region 123, the N-type semiconductor region 122, and the P_SUB. When the battery management system is connected to the charger and the gate control signal VGS is at a low level, the negative voltage may be generated in the charging pin 17. That is, the charge gate signal CHG may be reduced to a negative voltage.

At this time, the parasitic transistor Q2 is a pnp transistor and an emitter of the parasitic transistor Q2 is connected to the charge gate signal CHG. Then, since an emitter voltage of the parasitic transistor Q2 is smaller than a base voltage, the parasitic transistor Q2 is not turned on.

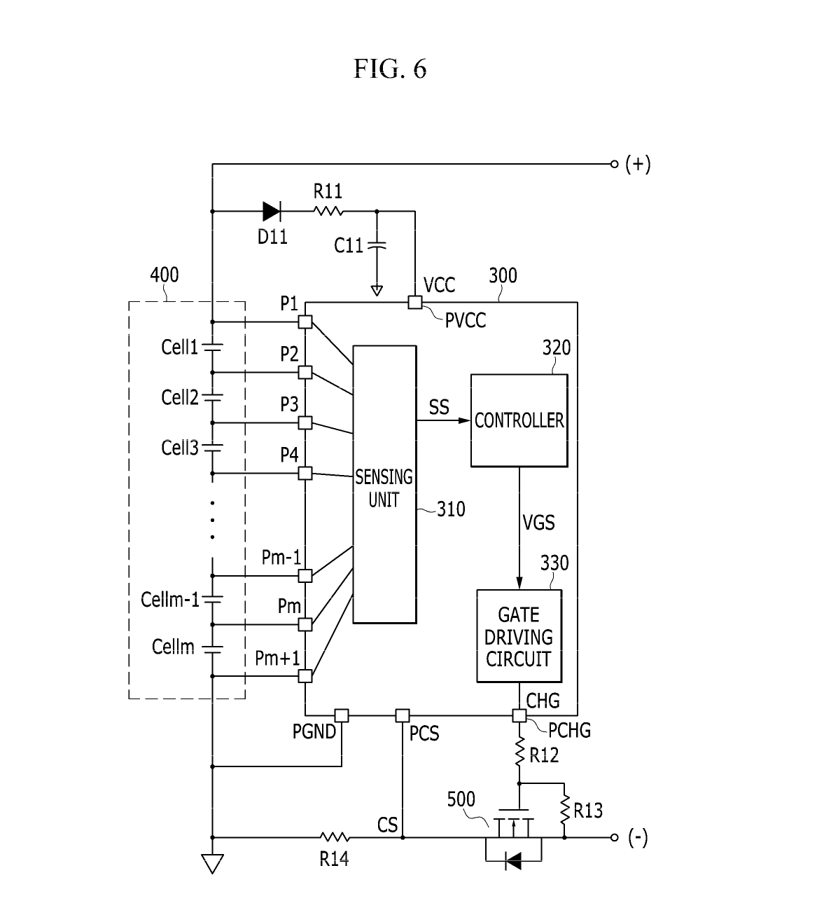

FIG. 6 is a view illustrating a battery management system including a gate driving circuit according to an exemplary embodiment.

As illustrated in FIG. 6, a plurality of cells Cell1 to Cellm are serially connected to a battery pack 400. Both ends of each of the cells of the battery pack 400 are connected to a battery management system 300. To be specific, a plurality of cell voltage pins P1 to Pm+1 formed in the battery management system 300 are connected to anodes or cathodes of the corresponding battery cells Cell1 to Cellm.

The battery pack 400 is connected between a first output terminal(+) and a second output terminal(−). A charger (not shown) or a load (not shown) may be connected between the first output terminal (+) and the second output terminal(−).

The battery management system 300 according to the exemplary embodiment includes a sensing unit 310, a controller 320, and a gate driving circuit 330.

A current rectified by a diode D11 charges a capacitor C11 through a resistor R11. The capacitor C11 supplies a voltage VCC required for an operation of the battery management system 300. The voltage VCC is supplied to the battery management system 300 through a voltage pin PVCC.

A current sensing pin PCS is connected to one end of a resistor R14 and the other end of the resistor R14 is connected to a ground and a cathode of the battery pack 400. A voltage generated by a current that flows through the resistor R14 is input to the battery management system 300 through the current sensing pin PCS.

The sensing unit 310 measures voltages of the plurality of battery cells Cell1 to Cellm and measures a battery current through a sensing voltage CS input through the resistor R14. The sensing unit 310 generates measurement information SS based on the measurement result and transmits the measurement information SS to the controller 320.

The controller 320 controls a cell balancing operation, charging, and discharging in accordance with the measurement information SS. For example, the controller 320 generates the gate control signal VGS for controlling charging.

A gate driving circuit 330 may have the same structure as that of the gate driving circuit 10 illustrated in FIG. 2. Detailed description of the above will be omitted. A gate driving circuit 330 generates the charge gate signal CHG for controlling a switching operation of a charging switch 500 in accordance with the gate control signal VGS.

The charging switch 500 is formed of an N type transistor. However, the exemplary embodiment is not limited thereto. A drain of the charging switch 500 is connected to a cathode of the battery pack 400 and the ground. A source of the charging switch 500 is connected to the second output terminal(−). A gate of the charging switch 500 receives the charge gate signal CHG through a resistor R12.

A resistor R13 is connected between a gate terminal of the charging switch 500 and the second output terminal(−). The resistor R12 is connected between a charging pin PCHG and a gate terminal of the charging switch 500.

For example, when the charger is connected to the battery management system in a state where the charging switch 500 is in an off state, a negative voltage may be generated in the charging pin PCHG. At this time, since an emitter voltage of the parasitic transistor (Q2 illustrated in FIG. 5) is a negative voltage, the parasitic transistor Q2 is not turned on.

Therefore, according to the exemplary embodiment, unlike in a conventional art, in a state where the charger is connected to the battery pack 400 and the charging switch 500 is in an off state, a current supplied from the battery management system 300 to the gate of the charging switch 500 is not generated.

Therefore, an erroneous operation of the charging switch 500 is not generated and it is possible to prevent the battery management system 300 from being damaged.

The embodiment is not limited to the above description but a gate driving circuit according to another embodiment may include a zener diode instead of the resistor between the gate and the source of the second transistor.

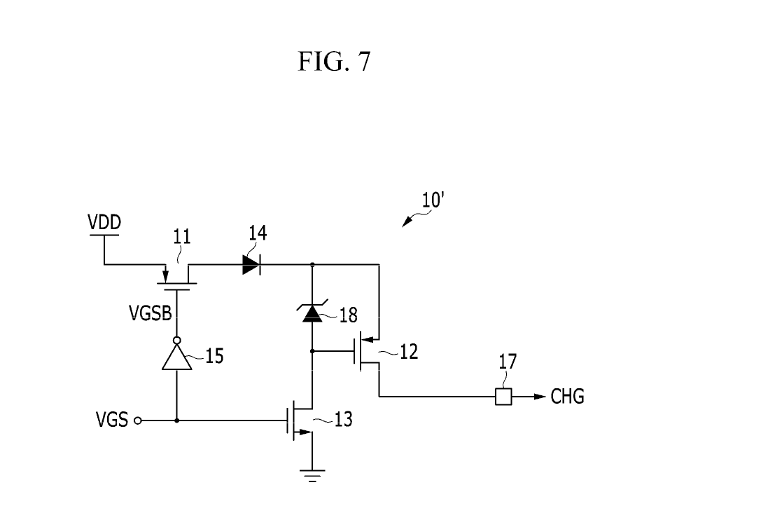

FIG. 7 is a view illustrating a gate driving circuit according to another exemplary embodiment.

In comparison with the gate driving circuit 10 illustrated in FIG. 2, a gate driving circuit 10′ illustrated in FIG. 7 includes a zener diode 18 instead of the resistor 16 and the other elements of the gate driving circuit 10′ are the same as those of the gate driving circuit 10.

As illustrated in FIG. 7, an anode of the zener diode 18 is connected to the gate of the second transistor 12 and a cathode of the zener diode 18 is connected to the source of the second transistor 12.

When the gate control signal VGS is at a high level, the first transistor 11 is turned on by the low level inverted gate control signal VGSB and the third transistor 13 is turned on by the high level gate control signal VGS. Then, the gate of the second transistor 12 is connected to the ground and the source of the second transistor 12 is connected to the power supply voltage VDD through the diode 14 so that the second transistor 12 is turned on.

At this time, the zener diode 18 is conducted by the power supply voltage VDD and a gate-source voltage of the second transistor 12 is uniformly maintained by a voltage of both ends of the zener diode 18, that is, a zener voltage.

When the gate control signal VGS is at a low level, the first transistor 11 is turned off by the high level inverted gate control signal VGSB and the third transistor 13 is turned off by the low level gate control signal VGS.

At this time, the zener diode 18 is non-conducted and the second transistor 12 is turned off. As the second transistor 12 is turned off, the charge gate signal CHG is at a low level.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

first to third transistors 11 to 13, diode 14

inverter 15, resistors 16 and R11, battery pack 400

battery management system 300, charging switch 500

diodes D11 and D1, capacitor C11

sensing unit 310, controller 320

gate driving circuit 330, transistors M1, M2, and M3

What is claimed is:

1. A gate driving circuit coupled to a gate of a charging switch through a charging pin, comprising:
a first transistor configured to perform a switching operation in accordance with a gate control signal to control a connection between a power supply voltage and a charging pin;
a second transistor coupled between the charging pin and the first transistor; and
a diode coupled between the first transistor and the second transistor and positive biased by the power supply voltage,
wherein a switching operation of the second transistor is controlled in synchronization with a switching state of the first transistor.

2. The gate driving circuit of claim 1, further comprising:
a third transistor configured to perform a switching operation in accordance with the gate control signal to control the switching operation of the second transistor.

3. The gate driving circuit of claim 2, wherein a first terminal of the first transistor is coupled to the power supply voltage, a second terminal of the first transistor is coupled to an anode of the diode, and an inverted gate control signal obtained by inverting the gate control signal is input to a gate of the first transistor.

4. The gate driving circuit of claim 3, wherein the gate control signal is input to a gate of the third transistor.

5. The gate driving circuit of claim 3, wherein a first terminal of the third transistor is coupled to ground, a second terminal of the third transistor is coupled to a gate of the second transistor, and the gate control signal is input to the gate of the third transistor.

6. The gate driving circuit of claim 5, wherein a first terminal of the second transistor is coupled to a cathode of the diode and a second terminal of the second transistor is coupled to the charging pin.

7. The gate driving circuit of claim 1, further comprising:
a resistor coupled between a gate electrode of the second transistor and a first terminal of the second transistor.

8. The gate driving circuit of claim 1, further comprising:
a zener diode including an anode coupled to the gate electrode of the second transistor and a cathode coupled to a first terminal of the second transistor.

9. A gate driving circuit, comprising:
a first transistor coupled to a power supply voltage, the first transistor on a P-type semiconductor substrate;
a diode including an anode coupled to the first transistor, the diode on the P-type semiconductor substrate; and
a second transistor coupled to a cathode of the diode, the second transistor on the P-type semiconductor substrate,
wherein the second transistor comprises:
a first N-type semiconductor region implanted in the P-type semiconductor substrate;
a first P-type semiconductor region coupled to a cathode of the diode and the first N-type semiconductor region; and
a second P-type semiconductor region implanted in the first N-type semiconductor region.

10. The gate driving circuit of claim 9, wherein the diode comprises:
a second N-type semiconductor region coupled to the first P-type semiconductor region and implanted in the P-type semiconductor substrate; and
a third P-type semiconductor region implanted in the second N-type semiconductor region.

11. The gate driving circuit of claim 10, wherein the first transistor comprises:
a third N-type semiconductor region implanted in the P-type semiconductor substrate;
a fourth P-type semiconductor region implanted in the third N-type semiconductor region and coupled to the power supply voltage; and
a fifth P-type semiconductor region implanted in the third N-type semiconductor region and coupled to the third P-type semiconductor region.

12. The gate driving circuit of claim 9, further comprising:
a third transistor coupled between the gate electrode of the second transistor and a ground.

13. The gate driving circuit of claim 12, wherein the third transistor comprises:
a fourth N-type semiconductor region coupled to the gate electrode of the second transistor and the first P-type semiconductor region through a resistor and implanted in the P-type semiconductor substrate;
a sixth P-type semiconductor region implanted in the fourth N-type semiconductor region; and
a fifth N-type semiconductor region implanted in the sixth P-type semiconductor region.

14. The gate driving circuit of claim 12, wherein a signal supplied to a gate electrode of the first transistor and a signal obtained by inverting a signal supplied to a gate electrode of the third transistor are inverted to each other.

15. The gate driving circuit of claim 9, wherein a parasitic transistor formed among the P-type semiconductor substrate, the first N-type semiconductor region, and the second P-type semiconductor region is not turned on by a negative voltage supplied to the second P-type semiconductor region when the second transistor is turned off.

16. A battery management system for managing a battery pack including a plurality of cells, comprising:
a charging pin coupled to a gate of a charging switch for controlling charge of the battery pack;
a gate driving circuit configured to switch the charging switch; and
a controller configured to generate a gate control signal based on measuring voltages of the plurality of cells and a current that flows through the battery pack,
wherein the gate driving circuit comprises:
a first transistor configured to perform a switching operation in accordance with an inverted gate control signal obtained by inverting the gate control signal to control a connection between a power supply voltage and a charging pin;
a second transistor coupled between the charging pin and the first transistor; and
a diode coupled between the first transistor and the second transistor and positive biased by the power supply voltage,
wherein a switching operation of the second transistor is controlled in synchronization with a switching state of the first transistor.

17. The battery management system of claim 16, wherein the gate driving circuit further comprises
a third transistor configured to perform a switching operation in accordance with the gate control signal to control the switching operation of the second transistor.

18. The battery management system of claim 17, wherein a first terminal of the first transistor is coupled to the power supply voltage, a second terminal of the first transistor is coupled to an anode of the diode, and the inverted gate control signal is input to a gate of the first transistor.

19. The battery management system of claim 18, wherein a first terminal of the third transistor is coupled to a ground, a second terminal of the third transistor is coupled to a gate of the second transistor, and the gate control signal is input to a gate of the third transistor.

20. The battery management system of claim 19, wherein a first terminal of the second transistor is coupled to a cathode of the diode and a second terminal of the second transistor is coupled to the charging pin.
